(19) United States
(12) Patent Application Publication
(10) Pub. No.: US 2008/0260132 A1
(43) Pub. Date: Oct. 23, 2008

(54) Low bandwidth but high capacity telephone conference system

(75) Inventors: Mark Zhang, Xi' an (CN); Cheng-Jen Yang, Hsinchu (TW)

Correspondence Address: BIRCH STEWART KOLASCH & BIRCH, PO BOX 747, FALLS CHURCH, VA, 22040-0747, US

(73) Assignee: BROWAN COMMUNICATIONS, Inc.

(21) Appl. No.: 11/785,851

(22) Filed: Apr. 20, 2007

(51) Int. Cl. H04M 3/42

(52) U.S. Cl. 379/202.01

(57) ABSTRACT

A teleconference system comprises VoIP server, a rootnode presider terminal, a first level conference element and a second level conference element. The first level conference element includes the rootnode presider terminal and at least one first participant terminals as childnode of the rootnode presider terminal, wherein at least one of the first participant terminals is the candidate to be selected as second level presider terminal. The second level conference element includes the second level presider terminal and at least one second participant terminals as childnode of the second level presider terminal. The VoIP server is coupled to the rootnode presider terminal, first participant terminals and second participant terminals.

### FIELD OF THE INVENTION

The present invention relates generally to a teleconferencing system, and more particularly to a system for establishing and controlling a coral architecture teleconferencing system.

### BACKGROUND OF THE INVENTION

Although the telephone industry is heavily computerized, the procedure for establishing and joining conference calls is still very much a manual one. Conference calls are reserved by calling a human operator who receives the information, types the information into a computer, confirms the reservation, and then provides the caller with a call-in number and a password for use when joining the conference. Similarly, when joining the conference, each participant terminal again calls a human operator. The operator asks each participant terminal for the conference password and validates it, sometimes obtains information about the caller, and ultimately connects the participant terminal into the conference call. Some telephone companies are beginning to allow users to make their own reservations via Internet, although participant terminals must still go through a human operator in order to join a conference. There also exist some Internet applications for starting teleconferences from a browser, such as the Sprint Internet Conference Center. The Sprint system allows users to set up and manage conference calls from a browser, whereby the users log in to the Sprint conference web site and enter the telephone numbers of the participant terminals with whom that they would like a conference, and the conference begins almost immediately.

Numerous teleconferencing systems provide a number of different methods for establishing a telephone conference call or teleconference between multiple individuals. One of the most common methods for establishing a teleconference requires the teleconference host or sponsor, to schedule the teleconference with a human teleconference operator in advance of the teleconference. The operator uses a maintenance and administrative terminal to program a teleconference bridge, connected to the public switched telephone network (“PSTN”).

Some teleconferencing systems have provided a conferencing feature wherein the host is able to create a list containing attendees' telephone numbers in a memory along with a conferencing code. The host must pre-enter in the telephone number of each attendee in the memory. To establish a conference call, the host enters the conference code. Circuitry detects the conferencing code and automatically calls and conferences together each attendee at the telephone numbers stored in memory.

FIG. 1 shows a current teleconferencing system according to one prior art for establishing and controlling a mixing voice teleconference system by one teleconference server 10. In one case, voice processing is based on server mixing voice technology to fulfill. In such case, teleconferencing system includes one teleconference server 10 and multiple, for example three participant terminals. A participant terminal 11 sends a voice data stream A to the server 10; participant terminal 12 sends a voice data stream B to the server 10; participant terminal 13 transmits a voice data stream C to the server 10. The teleconference server 10 receives voice data streams A, B, C from participant terminal 11, participant terminal 12 and participant terminal 13, respectively. Then, voice data streams A, B and C are mixed to be processed as M on the server 10, i.e. M=A+B+C. Subsequently, the server 10 transmits mixing voice data streams M to participant terminal 11, participant terminal 12 and participant terminal 13, respectively. Accordingly, participant terminal 11, participant terminal 12 and participant terminal 13 receive the mixing voice data streams M from the server 10 and then reproduce the mixing voice after decoding the mixing voice data streams M.

In server mixing voice teleconference system, processing capability and network bandwidth of the server 10 need to be high enough to process and transfer control information and voice data streams of the whole system. Performance of the teleconference will be promptly drop while capacity of teleconferencing system is increased, and thereby numbers of teleconference sponsors, conferees and conferences are limited due to over-loaded server 10.

FIG. 2 shows another current teleconferencing system according to one prior art for establishing and controlling a mixing voice teleconference system by one presider terminal or sponsor 21. In one case, voice processing is based on client terminal mixing voice technology to fulfill. In such case, teleconferencing system includes one VoIP server 20, one presider terminal 21 and multiple, such as three participant terminals 22, 23, 24. The presider terminal 21 is responsible for calling each of the participant terminals and establishing a P2P connection between the presider terminal 21 and participant terminals 22, 23 and 24 via VoIP server 20. If participant terminal 24 can not establish a P2P connection with the presider terminal 21, then a relay connection is created between the presider terminal 21 and participant terminal 24 via the VoIP server 20 transferring. In such system, the VoIP server 20 manages and transfers higher bandwidth voice data streams from participant terminals.

Participant terminal 22 sends a voice data stream A to the presider terminal 20; participant terminal 23 sends a voice data stream B to the presider terminal 20; participant terminal 24 transmits a voice data stream C to the presider terminal 21; presider terminal 21 creates a voice data stream P. The presider terminal 21 receives voice data streams A, B, C and P from participant terminal 22, participant terminal 23 and participant terminal 24 and itself, respectively. Then, voice data streams A, B, C and P are mixed to be processed as M on the presider terminal 21, i.e. M=A+B+C+P. Subsequently, the presider terminal 21 transmits the mixing voice data streams M to participant terminal 22, participant terminal 23 and participant terminal 24, respectively. Accordingly, participant terminal 22, participant terminal 23 and participant terminal 24 receive the mixing voice data streams M from presider terminal 21 and then reproduce the mixing voice after decoding the mixing voice data streams M. The presider terminal 21 reproduces the mixing voice after performing an echo cancellation process.

In client terminal mixing voice teleconference system, all of the participant terminals send themselves voice data streams to the presider terminal, and the presider terminal executes a process for mixing corresponding voice data streams from participant terminals and identical microphone signal of the presider terminal. The presider terminal 21 is responsible for delivering the mixing voice data streams M to each of the participant terminals, respectively. Similarly, processing capability and network bandwidth of the presider terminal 21 need to be high enough to process largely voice data streams of the whole system. Performance of the teleconference will be promptly drop while capacity of teleconferencing system is increased, and thereby numbers of VoIP teleconference sponsors, conferees and conferences are limited due to over-loaded presider terminal. Accordingly, client terminal mixing voice teleconference system can not resolve the issue of capacity of the teleconference.

According to the above-mentioned, we all know that telephone conference is an important functionality application in VoIP (Voice over IP) system. Currently, VoIP system has fulfilled a good conference-related functionality that allows several individuals to participate in a telephone conference call and allows several conference calls to be in progress at any given time. Unfortunately, current teleconferencing systems provide a limited number of control interfaces to teleconference sponsors and conferees. Voice quality of teleconference is promptly drop while capacity of teleconferencing system is increased. In addition, current teleconferencing systems can not provide a high capacity and expanded numbers of teleconference sponsors, conferees and conferences due to limited bandwidth and CPU processing capability. Therefore, the present invention provides a new telephone conference architecture system to resolve the above-mentioned issues.

### SUMMARY OF THE INVENTION

The main purpose of the present invention is provided a teleconferencing system which has more greatly conference capacity (CC) than the prior art teleconferencing system.

Another purpose of the present invention is provided a teleconferencing system which fulfills low bandwidth but high capacity conference capacity (CC) without additional network expenses.

The present invention provides a teleconference system comprising VoIP server, a rootnode presider terminal, a first level conference element and a second level conference element. The first level conference element includes the rootnode presider terminal and at least one first participant terminals as childnode of the rootnode presider terminal, wherein at least one of the first participant terminals is the candidate to be selected as second level presider terminal. The second level conference element includes the second level presider terminal and at least one second participant terminals as childnode of the second level presider terminal. The VoIP server is coupled to the rootnode presider terminal, first participant terminals and second participant terminals.

The teleconference system further comprises a third level conference element including a third level presider terminal and at least one third participant terminals as childnode of said second level presider terminal, wherein the third level presider terminal is selected from said third participant terminals.

The rootnode presider terminal is coupled to the first participant terminals via the VoIP server calling. The second level presider terminal is coupled to the second participant terminals via the VoIP server calling. The third level presider terminal is coupled to the third participant terminals via said VoIP server calling.

In one embodiment, the teleconference system establishes between the first, second and third participant terminals is an audio conference; in another embodiment, the teleconference system establishes between the first, second and third participant terminals is a video conference.

The second participant terminals send first audio data streams to the second level presider terminal for mixing. The second level presider terminal produces second audio data stream for mixing the first audio data streams, thereby producing a first mixed audio data stream. The first mixed audio data stream is sent by the second level presider terminal to the rootnode presider terminal for mixing.

The rootnode presider terminal produces third audio data stream for mixing the first mixed audio data stream, thereby producing a second mixed audio data stream. The rootnode presider terminal produces third audio data stream for mixing the first mixed audio data stream, thereby producing a second mixed audio data stream. The second mixed audio data stream is sent by the rootnode presider terminal to the first participant terminals. The first participant terminals reproduces the second mixed voice data stream after decoding. The second mixed audio data stream is sent by the second level presider terminal to the second participant terminals. The second participant terminals reproduces the second mixed voice data stream after decoding. The rootnode presider terminal reproduces the second mixed voice data stream after performing an echo cancellation process. The second level presider terminal reproduces the second mixed voice data stream after performing an echo cancellation process.

### BRIEF DESCRIPTION OF THE DRAWINGS

For a better understanding of the present invention and to show how it may be implemented, reference will now be made to the following drawings:

FIG. 1 is a current teleconferencing system according to one prior art;

FIG. 2 is a current teleconferencing system according to another prior art;

FIG. 3 shows a teleconferencing system according to one embodiment of the present invention;

FIG. 4 shows a teleconferencing architecture, topology according to the present invention.

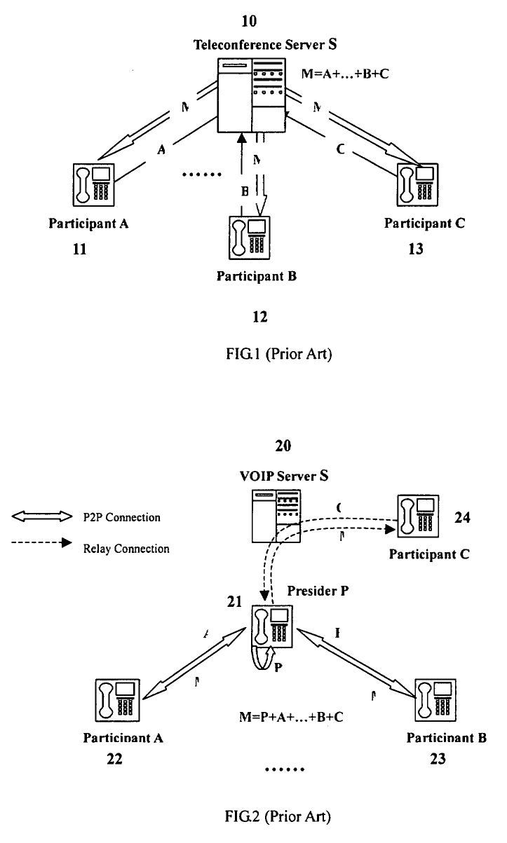

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

In the present invention, a coral architecture teleconferencing system is provided. Those skilled in the art will recognize, however, that a VoIP server could be used for the present invention. The teleconferencing system of the present invention is based on client terminal mixing voice teleconferencing system to expand. In the preferred embodiment, teleconferencing system includes VoIP server, main presider terminal and multiple branch presider terminals and multiple participant terminals. VoIP server 20 could transfer voice data streams from some participant terminals. The main presider terminal, multiple branch presider terminals and multiple participant terminals are constituted by an internet telephone structure.

The teleconference system of the present invention establishes between rootnode presider terminal, branch presider terminals and participant terminals to be an audio or a video conference.

In the present invention, the main presider terminal regards as rootnode, and the rootnode has multiple first participant terminals as its childnodes for mixing voice data streams. One of the first participant terminals is the candidate to be selected as a second level presider terminal. As the same way, the second level presider terminal has multiple second participant terminals as its childnodes for mixing voice data streams. Following the same process, a coral architecture teleconferencing system of the present invention is made.

In one embodiment, the branch presider terminal and its childnodes can be selected by a determined algorithm. While some nodes in the network in linking-fail status, original some branch presider terminal or its childnodes can be replaced by some terminals via a determined algorithm to maintain the conference processing.

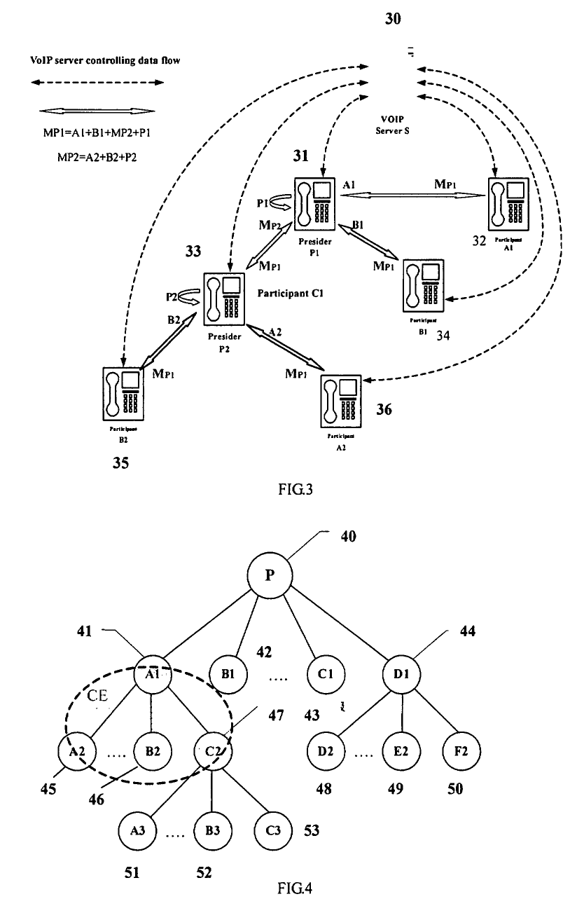

FIG. 3 shows a teleconferencing system according to the present invention. In one preferred case, voice processing is based on client terminal mixing voice technology to fulfill. In one embodiment, teleconferencing system includes VoIP server 30, main presider terminal 31 and branch presider terminal 33 and four participant terminals 32, 34, 35, 36. The main presider terminal 31 regards as a sponsor or rootnode having three participant terminals 32, 33, 34, wherein one of the participant terminals 32, 33 or 34 is the candidate to be selected as a second level presider terminal of the system. For example, participant terminal 33 is selected as a second level presider terminal having two participant terminals 35, 36. Moreover, further level presider terminal may be selected depending on practical necessity. The embodiment system is used for illustrating and not used for limiting the scope of the present invention.

In FIG. 3, the main presider terminal 31 is responsible for calling each of the participant terminals and establishing a P2P connection between the presider terminal 31 and participant terminals 32, 33 and 34 via VoIP server 30. As the same, the second level presider terminal 33 is responsible for calling each of the participant terminals and establishing a P2P connection between the second level presider terminal 33 and participant terminals 35, 36 via VoIP server 30. In one embodiment, if participant terminal fails to establish a P2P connection with corresponding presider terminal, then a relay connection is created between the corresponding presider terminal and participant terminals via the VoIP server 30 transferring. In such case, the VoIP server 30 manages and transfers higher bandwidth voice data streams from some participant terminals.

Participant terminal 36 sends a voice data stream A2 to the second level presider terminal 33; participant terminal 35 sends a voice data stream B2 to the second level presider terminal 33; the second level presider terminal 33 sends a voice data stream P2. Similarly, the participant terminal 32 sends a voice data stream Al to the main presider terminal 31; participant terminal 34 sends a voice data stream B1 to the main presider terminal 31. The second presider terminal 33 receives voice data streams A2, B2 and P2 from participant terminal 36, participant terminal 35 and itself, respectively, and then mixing voice data streams A2, B2 and P2 to be as Mp1 by the second presider terminal 33, i.e. Mp2=A2+B2+P2. Similarly, the second presider terminal 33 transmits the mixing voice data streams Mp2 to the main presider terminal 31. Accordingly, the main presider terminal 31 receives voice data streams A1, B1, Mp2 and P1 from participant terminal 32, participant terminal 34, participant terminal 33 and itself, respectively, and then mixing voice data streams A1, B1, P1 and Mp2 to be as Mp1 by the main presider terminal 31, i.e. Mp1=A1+B1+P1+Mp2. The main presider terminal 31 transmits the mixing voice data stream Mp1 to participant terminal 32, participant terminal 33 and participant terminal 34, respectively. Accordingly, participant terminal 32, participant terminal 33 and participant terminal 34 receive the mixing voice data streams Mp1 from the main presider terminal 31 and then reproduce the mixing voice after decoding the mixing voice data streams Mp1. The main presider terminal 31 reproduces the mixing voice after performing an echo cancellation process.

Similarly, the second presider terminal 33 transmits the mixing voice data stream Mp1 to participant terminal 35 and participant terminal 36, respectively. The participant terminal 35 and participant terminal 36 receive the mixing voice data streams Mp1 from the second presider terminal 33 and then reproduce the mixing voice after decoding the mixing voice data streams Mp1. The second presider terminal 33 reproduces the mixing voice after performing an echo cancellation process.

Accordingly, all of the conferees in the teleconferencing system of the present invention can listen to the whole audio, voice during the telephone conference processing. The application can be applied to a large-scale telephone conference, a topical subject telephone conference, on-line (internet) concert, on-line course of lectures, on-line real time sale or distributed on-line broadcasting.

FIG. 4 shows a teleconferencing architecture, topology according to the present invention. The conference capacity of the preferred embodiment is higher than the prior arts. In one embodiment, the teleconferencing architecture comprises three level presider terminals, but not limited three level presider terminals, more than three presider terminals is available in the present invention. A sponsor as a first presider terminal 40 is provided in a teleconferencing system of the present invention. The first presider terminal 40 as rootnode has multiple childnodes, such as participant terminals 41, 42, 43 . . . 44 to be as voice data streams resource provided for being mixed. One or more of the above mentioned participant terminals, such as participant terminals 41 and 44, are selected as a second level presider terminal. Similarly, second presider terminal 41 and 44 have multiple childnodes, such as participant terminals 45, 46 . . . 47 and participant terminals 48, 49 . . . 50, respectively to be as voice data streams resource provided for being mixed as well.

Furthermore, one or more of the above mentioned childnodes of the participant terminals 45, 46 . . . 47, such as participant terminals 47, is selected as a third level presider terminal. Similarly, participant terminals 51, 52 . . . 53 could act the multiple childnodes of the third level presider terminal 47. The participant terminals 51, 52 . . . 53 are introduced as voice data streams resource for data mixing as mentioned above.

From above description, N-th level presider terminal of the teleconferencing system has multiple childnodes to be as voice data streams resource provided for being mixed, thereby the mixing voice data streams from its childnodes and itself on N-th level presider terminal becomes as one of mixing voice data streams resource of the (N-1)-th level mother presider terminal.

In one case, presider terminal and its childnodes constitute a conference element (CE). The presider terminal labels as a mother node. Therefore, the teleconferencing architecture is constituted by multiple conference elements having its corresponding mother nodes, wherein one of the mother nodes is a rootnode while others mother nodes act as 2˜N-th level presider terminals. For example, first presider terminal 40 and its childnodes, participant terminals 41, 42, 43, 44 constitute a conference element, wherein the first presider terminal 40 is designated as the mother (root) node. The second presider terminal 41 and its childnodes, participant terminals 45, 46, 47 constitute a conference element as well, in the subsystem, the second presider terminal 41 is defined as the mother node. Similarly, The third presider terminal 47 and its childnodes, participant terminals 51, 52, 53 constitute a conference element, wherein the third presider terminal 47 is mother node. Another second presider terminal 44 and its childnodes, participant terminals 48, 49, 50 also constitute a conference element, wherein the second presider terminal 44 performs the function of mother node.

From above mentioned description, mother node is representative as a rootnode (first level presider terminal) or N-th level presider terminal, wherein N is defined as a mother level of the conference element. Thus, mother level of the conference element with the first level presider terminal 40 is one. Mother level of the conference element with the second level presider terminal 41 or 44 is two. Mother level of the conference element with the third level presider terminal 47 is three. Similarly, mother level of the conference element with N-th level presider terminal 47 is N.

In addition, the nodes free of childnode are defined as a leaf node. For example, the nodes 42, 43, 45, 46, 48, 49, 50, 51, 52 and 53 are leaf nodes. In a conference element, each one of the childnodes is only establishing a P2P connection with its mother node. For instance, node 41-node 45, node 4146, node 41-node 47 establish a P2P connection.

In one embodiment, number of the largest level presider terminal is defined as conference level of the teleconferencing system. For example, in FIG. 4, the teleconferencing system has first level presider terminal 40, second level presider terminal 41, 44 and third level presider terminal 47; therefore conference level of teleconferencing system is three.

The node level is defined as the same level with its mother level of the mother node of the conference element. For example, the node level of the rootnode 40 is one; the node level of the second level presider terminal 41, 44 is two; the node level of the third presider terminal 47 is three. Similarly, the node level of node 42, 43 as the same level with its mother node 40 is one; the node level of node 46, 49 as the same level with its mother node 41, 44 is two, based on the same reason, the node level of node 51, 52, 53 as the same level with its mother node 47 is three.

Moreover, conference capacity (CC) is defined as maximum of total available nodes of the teleconferencing system. Conference element capacity (CEC) refers to the maximum of total available nodes in the conference element. Conference loading (CL) is defined as current total available nodes of the teleconferencing system. Conference loading (CL) is for example 14, as shown in FIG. 4. Conference element loading (CEL) is defined as current total available nodes in the conference element, for example 4, as the second level conference element, shown in FIG. 4. System conference capacity refers to the available telephone conference quantities on the whole VoIP system.

Assume, conference capacity (CC) of conventional teleconferencing system (only one conference element level) is equal to C¹=N; conference capacity (CC) of teleconferencing system of the present invention (with k conference element level) is equal to C^{k} following as the equation,

$${C}^{k} = {N}^{k} + {N}^{k - 1} + {N}^{k - 2} + … + 1 = {\sum }_{m = 0}^{k} {N}^{m}$$

Therefore, teleconferencing system of the present invention provide more greatly conference capacity (CC) than the prior art teleconferencing system.

Though conference capacity (CC) of teleconferencing system of the present invention is far more than the prior art, network expenses of the whole teleconferencing system is almost the same as the prior art teleconferencing system.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A teleconference system, comprising:
a VoIP server; and
a first level conference element including a rootnode presider terminal and at least one first participant terminals as a first childnode of said rootnode presider terminal, wherein at least one of said first participant terminals is the candidate to be selected as second level presider terminal, wherein said VoIP server is coupled to said rootnode presider terminal and said first participant terminals.

2. The teleconference system of claim 1, further comprising a second level conference element including said second level presider terminal and at least one second participant terminals as a second childnode of said second level presider terminal, wherein at least one of said second participant terminals is the candidate to be selected as third level presider terminal.

3. The teleconference system of claim 2, further comprising a third level conference element including a third level presider terminal and at least one third participant terminals as a third childnode of said second level presider terminal, wherein said third level presider terminal is the candidate to be selected as fourth level presider terminals.

4. The teleconference system of claim 1, wherein said rootnode presider terminal is coupled to said first participant terminals via said VoIP server calling.

5. The teleconference system of claim 2, wherein said second level presider terminal is coupled to said second participant terminals via said VoIP server calling.

6. The teleconference system of claim 3, wherein said third level presider terminal is coupled to said third participant terminals via said VoIP server calling.

7. The teleconference system of claim 1, wherein said teleconference system establishes between said rootnode presider terminal and said first participant terminals is an audio conference.

8. The teleconference system of claim 1, wherein said teleconference system establishes between said rootnode presider terminal and said first participant terminals is a video conference.

9. The teleconference system of claim 2, wherein said second participant terminals send first audio data streams to said second level presider terminal for mixing.

10. The teleconference system of claim 9, wherein said second level presider terminal produces second audio data stream for mixing said first audio data streams, thereby producing a first mixed audio data stream.

11. The teleconference system of claim 10, wherein said first mixed audio data stream is sent by said second level presider terminal to said rootnode presider terminal for mixing.

12. The teleconference system of claim 11, wherein said rootnode presider terminal produces third audio data stream for mixing said first mixed audio data stream, thereby producing a second mixed audio data stream.

13. The teleconference system of claim 12, wherein said rootnode presider terminal produces third audio data stream for mixing said first mixed audio data stream, thereby producing a second mixed audio data stream.

14. The teleconference system of claim 13, wherein said second mixed audio data stream is sent by said rootnode presider terminal to said first participant terminals.

15. The teleconference system of claim 14, wherein said first participant terminals reproduces said second mixed voice data stream after decoding.

16. The teleconference system of claim 13, wherein said second mixed audio data stream is sent by said second level presider terminal to said second participant terminals.

17. The teleconference system of claim 16, wherein said second participant terminals reproduces said second mixed voice data stream after decoding.

18. The teleconference system of claim 13, wherein said rootnode presider terminal reproduces said second mixed voice data stream after performing an echo cancellation process.

19. The teleconference system of claim 13, wherein said second level presider terminal reproduces said second mixed voice data stream after performing an echo cancellation process.
